(19) United States
(12) Patent Application Publication
(10) Pub. No.: US 2010/0122156 A1
(43) Pub. Date: May 13, 2010

(54) DYNAMIC MARKUP LANGUAGE

(75) Inventors: David A. Eves, Crawley (GB); Richard S. Cole, Redhill (GB)

Correspondence Address: BURNS & LEVINSON, LLP, 125 SUMMER STREET, BOSTON, MA, 02110, US

(73) Assignee: AMBX UK LIMITED, Redhill (GB)

(21) Appl. No.: 12/621,021

(22) Filed: Nov. 18, 2009

Related U.S. Application Data
(63) Continuation of application No. 10/515,079, filed on Nov. 18, 2004.

(30) Foreign Application Priority Data
May 23, 2002 (GB) 0211897.4

(51) Int. Cl. G06F 17/00

(52) U.S. Cl. 715/234

(57) ABSTRACT

A method for generating a markup language document comprises accessing a pool of active markup language fragments, processing the fragments using at least one predetermined factor, and generating a markup language document accordingly. In this way, a declarative markup language document is derived, but with content that is effectively dynamic.

This invention relates to a method for generating a markup language document.

In order to provide content to a browser, for example web pages to an Internet browser, HTML (HyperText Markup Language) was developed. HTML is a markup language that is solely declarative, containing text and links to other documents. No interpretation by the browser is required. However the content that can be presented in this way is obviously limited. A number of solutions to this problem have been developed, principally JAVA, which is a programming language that allows the creation of small programs (applets) that can be addressed by links in HTML documents. In this way graphics and the like can be easily provided to a browser, and rendered to the user. A known limitation of HTML and JAVA is that the content so provided is effectively fixed. Even if a JAVA applet is authored to provide a sequence of images to imitate movement, whenever that JAVA applet is addressed, the same sequence of images will be displayed. A number of solutions to this problem have been proposed.

International patent application publication WO 02/17082 describes dynamic content assembly on edge-of-network servers in a content delivery network. The disclosure enables a content provider to dynamically assemble content at the edge of the Internet, preferably on content delivery network (CDN) edge servers. Preferably, the content provider leverages an “edge side include” (ESI) markup language that is used to define Web page fragments for dynamic assembly at the edge. Dynamic assembly improves site performance by caching the objects that comprise dynamically generated pages at the edge of the Internet, close to the end user. The content provider designs and develops the business logic to form and assemble the pages, for example, by using the ESI language within its development environment. Instead of being assembled by an application/web server in a centralised data centre, the application/web server sends a page template and content fragments to a CDN edge server where the page is assembled. Each content fragment can have its own cacheability profile to manage the “freshness” of the content. Once a user requests a page (template), the edge server examines its cache for the included fragments and assembles the page on the fly.

This prior art system however, is still based upon static content. The fragments that are used to fill the template to create a final document for rendering by a browser are predefined. There is no possibility for dynamic content.

United States patent application publication U.S. 2001/0037359 describes a system and method for a server-side browser including markup language graphical user interface, dynamic markup language rewriter engine and profile engine. The proposal is a system and method for customizing access and delivery of information distributed in a packet-based network. The system includes a user computer and a destination server computer separated by a server computer hosting a server-side browser (SSB). The SSB includes a markup language graphical user interface (MLGUI), a dynamic markup language rewriter engine (DMLRE) and a profiling engine (PE). The SSB may be configured as an intermediary infrastructure residing on the Internet providing customized information gathering for a user. The components of the SSB allow for controlling, brokering and distributing information more perfectly by controlling both browser functionality (on the client-side) and server functionality (on the destination site side) within a single point and without the necessity of incremental consents or integration of either side.

The system of this prior art publication is a filtering system based upon profiles. Content is taken from a number of sources, filtered, rewritten as a single source and provided to a user. This complicated system has the disadvantage, as before, that the content that is provided to the user is still, nevertheless, static content.

The article “A proposal for Dynamic XML without DOM & Scripts” by A. Sundararajan, available at http://sundararaian.tripod.com/dxml/dxml.ht-m, states that in dynamic web pages, the content and/or appearance of the web page varies with time. According to the article, currently, it is possible to create dynamic web pages (DHTML) using HTML DOM & Scripting. It states that there are known disadvantages with this approach, such as:—
Knowledge of scripting & DOM is essential for writing dynamic web pages.
HTML editors/tools generate script/DOM for dynamic web pages. However script generated by one tool cannot be processed by other tools. Specialized HTML comments are embedded by tools to even re-edit the HTML/JavaScript generated by the same tool.

The article describes the possibility of tag based, declarative, dynamic XML documents. A dynamic XML document is a document whose content and/or appearance varies with time. At an XML document level, dynamism involves changing an attribute or an element or text content of an element, at some time T.

While the ideas discussed in this article show that dynamic content for markup language documents is known, the solution offered by the ideas in this article have a number of drawbacks. Firstly, in order to maintain the dynamism of the content the client browser is required to have the additional functionality to process the tags that control the content. This prevents penetration of the technology amongst consumers and adds in a level of complexity that makes the authoring and handling of such documents more complicated. Secondly, once such a document is created, there is still only a small degree of dynamism achieved. The document and tags are fixed, the content will always act in a predictable fashion, and the process of creating the document is relatively inflexible.

It is therefore an object of the invention to provide a method of generating a markup language document that allows presentation of dynamic content, but does not have the drawbacks of the prior art.

According to the present invention, there is provided a method for generating a markup language document comprising accessing a pool of active markup language fragments, processing said fragments using at least one predetermined factor, and generating a markup language document accordingly.

Owing to the invention, it is possible to provide a markup language document that is dynamic in content, but does not require any adaptation on the part of the client browser to render that document. The choice of fragments for the pool and factors for the processing allow flexibility in the authoring process.

Advantageously, a predetermined factor is time. Another possibility for a predetermined factor is context. Preferably, the pool is generated from a plurality of sources. Advantageously, the pool is created by parsing of markup language sources to obtain active markup language fragments.

Embodiments of the invention will now be described, by way of example only, with reference to the accompanying drawings, in which:—

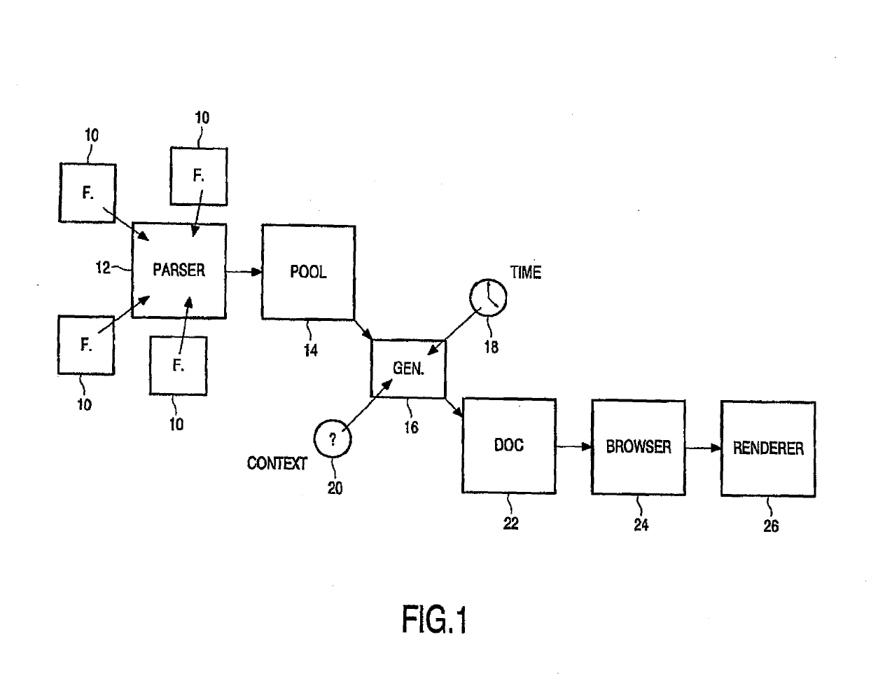

FIG. 1 is a schematic diagram of a system for generating a markup language document, and

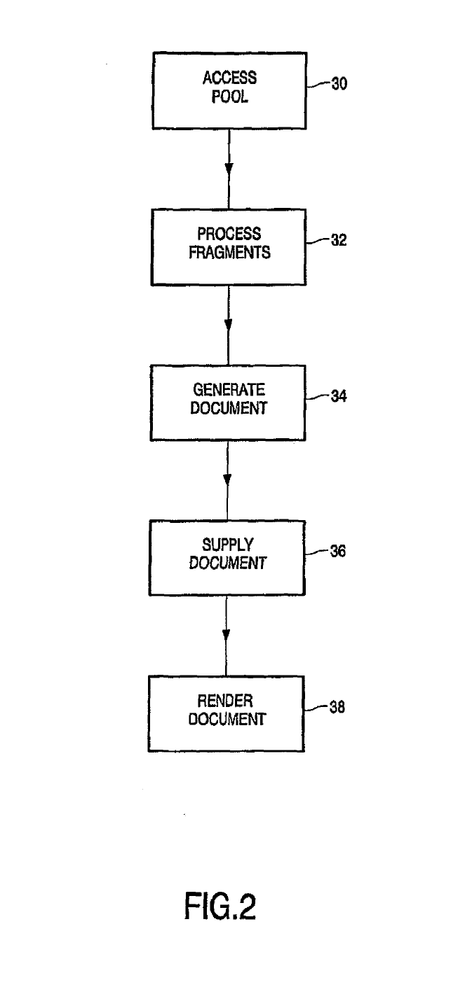

FIG. 2 is a schematic diagram of a method for generating a markup language document.

In the diagram of FIG. 1, active markup fragments 10 are provided to a parser 12. These fragments can originate from a plurality of sources, and are active in the sense that they refer to content that is dynamic, for example, requiring reference to variables to determine their actual output. An example of such a fragment would be:

```
1 <fragment> example
    <object> object1
        <when> flag then <location> 100, 100 </location> </when>
        <when> NOT flag then <location> 0,0 </location> </when>
    </object>
</fragment>
```

This fragment determines the location of object 1 depending upon whether a variable flag is true or false. This fragment is obviously very simple; the complexity of fragments is only limited by the ingenuity of their author(s). A number of such fragments are provided to the parser 12, which ascertains that they are of a suitable format for passing to a pool 14 of fragments. The parser 12 would generally be an XML parser that checks that each fragment 10 is XML compliant, discarding those that are not. This ensures robustness of the method.

A snapshot generator 16 is for generating a markup language document. The generator 16 achieves this by accessing the pool 14 of active markup language fragments, processing the fragments using at least one predetermined factor, and generating a markup language document accordingly. In the Figure, a first predetermined factor is time, shown schematically at 18, and a second predetermined factor is context, shown at 20. These factors are set either by an author, or by a suitable computer program working under predefined conditions.

Taking the example of an active markup fragment given above, if there is included in the context information the logical conditional, flag=TRUE, then the output from the snapshot generator for that fragment would be:

```
<fragment> example
    <object> object1
        <location> 100, 100 </location>
    </object>
</fragment>
```

All of the fragments 10 in the pool 14 are processed in this way. Any fragment 10 that refers to a variable or conditional for which the generator 16 does not have the requisite information is discarded. A markup language document 22 is therefore generated from the fragments 10 that are in the pool 14. This document 22 is totally declarative, and can be rendered by a conventional browser, without the requirement for any modification or adaptation of the client side browser. The snapshot generator 16 would normally be located on the server side of any network system, creating a document 22 for supplying to a browser 24, which passes the document 22 to a renderer 26 for rendering said document 22.

The method is summarised in FIG. 2, which shows the method for generating the markup language document 22 comprising accessing 30 the pool 14 of active markup language fragments 10, processing 32 the fragments 10 using at least one predetermined factor, and generating 34 the markup language document 22 accordingly. The method can further comprise supplying 36 the document 22 to the browser 24 and rendering 38 the document 22.

A significant advantage of this method is the flexibility in generating documents that is facilitated by the method. The snapshot generator 16 can access the same pool 14 of fragments, but using different values and conditionals for the factors time and/or context, to obtain new markup language documents. So, for example, the time value can be changed, and a new document is easily generated based upon this changed factor. Equally fragments 10 can be added or subtracted from the pool 14, as desired. The generator 16 can then access the pool 14 and process the fragments 10 as described above to produce a new updated document 22. The snapshot process is repeated as necessary to generate new snapshots as time passes and context changes.

A further advantage of the method is that, when creating documents using changing factors, it is not necessary to maintain a timeline. It is only relevant to know when the next single possible change takes place, whether this is a start or end time, or a context change. Adding new fragments or removing old ones has a similar effect. This results in an efficient procedure for the generation of multiple documents.

1-10. (canceled)

11. A method for dynamically generating a markup language document comprising:
A) accessing a plurality of active markup language fragments, the markup language fragments including a reference to one of a variable or condition that defines respective outputs thereof;
B) receiving a predetermined factor; and
C) generating a declarative markup language document by:
i) using the predetermined factor to satisfy all variable or condition references in a markup language fragment;
ii) discarding a markup language fragment, if the predetermined factor does not satisfy all variable or condition reference in markup language fragment; and
iii) repeating i) and ii) for the plurality of markup language fragments.

12. The method of claim 11 further comprising:
D) providing the declarative markup language document to a browser process.

13. The method of claim 12 further comprising:
E) rendering the document with the browser process.

14. The method of claim 12 further comprising:
E) providing the declarative markup language document to a rendering process; and
F) rendering the document with the rendering process.

15. The method of claim 11 further comprising:
D) compiling a pool of markup language fragments from a plurality of sources.

16. The method of claim 15 further comprising:
D) parsing the plurality of markup language fragments to verify compliance with a markup language prior to inclusion in the pool.

17. The method of claim 11 wherein the predetermined factor comprises context data.

18. The method of claim 11 wherein the predetermined factor comprises time data.

19. A system for dynamically generating a markup language document comprising:
A) a memory for storing a plurality of active markup language fragments, the markup language fragments including a reference to one of a variable or condition that defines respective outputs thereof;
B) means for receiving a predetermined factor; and
C) a generator, operably coupled to the memory and the means for receiving the predetermined factor, for generating a declarative markup language document from the plurality of markup language fragments comprising:
i) means for using the predetermined factor to satisfy any variable or condition reference in the markup language fragments; and
ii) means for discarding a markup language fragment, if the predetermined factor does not satisfy a variable or condition reference in the markup language fragment.

20. The system of claim 19 further comprising:
a parser for verifying that the plurality of active markup language fragments comply with a markup language prior to storage in memory.

21. The system of claim 19 in combination with:
a browser process to which the declarative markup language document is provided.

22. The system of claim 19 in combination with:
a rendering process to which the declarative markup language document is provided.

23. The system of claim 19 in combination with:
at least one source of active markup language fragments operably coupled to the memory.

24. The system of claim 19 wherein the predetermined factor comprises context data.

25. The system of claim 19 wherein the predetermined factor comprises time data.

26. A method for dynamically generating a markup language document comprising:
A) providing a snapshot generator capable of generating a declarative markup language document from a plurality of received markup language fragments, the snapshot generator comprising:
i) means for receiving and using a predetermined factor to satisfy any variable or condition reference in a plurality of markup language fragments; and
ii) means for discarding a markup language fragment, if the received predetermined factor does not satisfy a variable or condition reference in the markup language
B) receiving a first plurality of active markup language fragments with the snapshot generator, the first plurality of markup language fragments including a reference to one of a variable or condition that defines respective outputs thereof;
C) receiving a first predetermined factor with the snapshot generator;
D) generating a first declarative markup language document with the snapshot generator using the first predetermined factor and the first plurality of active markup language fragments;
E) receiving a second predetermined factor with the snapshot generator; and
F) generating a second declarative markup language document with the snapshot generator using the second predetermined factor and the first plurality of active markup language fragments;
wherein the first and second declarative markup language documents generated by the snapshot generator are different if values of the first and second predetermined factors are not equal.

27. The method of claim 26 further comprising:
G) providing one of the first and second declarative markup language documents to a browser process.

28. The method of claim 27 further comprising:
H) rendering one of the first and second declarative markup language documents with the browser process.

29. The method of claim 27 further comprising:
G) providing one of the first and second the declarative markup language documents to a rendering process; and
H) rendering one of the first and second the declarative markup language document with the rendering process

30. A method for dynamically generating a markup language document comprising:
A) providing a snapshot generator capable of generating a declarative markup language document from a plurality of received markup language fragments, the snapshot generator comprising:
i) means for receiving and using a predetermined factor to satisfy any variable or condition reference in a plurality of markup language fragments; and
ii) means for discarding a markup language fragment, if the received predetermined factor does not satisfy a variable or condition reference in the markup language;
B) receiving a first plurality of active markup language fragments with the snapshot generator, the first plurality of markup language fragments including a reference to one of a variable or condition that defines respective outputs thereof;
C) receiving a first predetermined factor with the snapshot generator;
D) generating a first declarative markup language document with the snapshot generator using the first plurality of active markup language fragments and the first predetermined factor;
E) receiving a second plurality of active markup language fragments with the snapshot generator, the second plurality of markup language fragments including a reference to one of a variable or condition that defines respective outputs thereof; and
F) generating a second declarative markup language document with the snapshot generator using the second plurality of active markup language fragments and the first predetermined factor;
wherein the first and second declarative markup language documents generated by the snapshot generator are different if the first and second plurality of active markup language fragments different.
